(19) United States
(12) Patent Application Publication
(10) Pub. No.: US 2013/0114162 A1
(43) Pub. Date: May 9, 2013

(54) HARD DISK DRIVE SYSTEM WITH OFF TRACK DETECTION MECHANISM AND METHOD OF MANUFACTURE THEREOF

(71) Applicants: Tao Zhang, San Ramon, CA (US); Brian K. Tanner, San Jose, CA (US); BongJin Lee, Fremont, CA (US); Chang Ik Kang, Santa Clara, CA (US)

(72) Inventors: Tao Zhang, San Ramon, CA (US); Brian K. Tanner, San Jose, CA (US); BongJin Lee, Fremont, CA (US); Chang Ik Kang, Santa Clara, CA (US)

(73) Assignee: SAMSUNG ELECTRONICS CO., LTD., Gyeonggi-Do (KR)

(21) Appl. No.: 13/289,278

(22) Filed: Nov. 4, 2011

(51) Int. Cl. G11B 33/14; G11B 5/10

(52) U.S. Cl. 360/97.19; 29/603.03

(57) ABSTRACT

A method of manufacture of a hard disk drive system includes: providing a base circuit board having a shock sensor and vibration sensors thereon; electrically connecting translational shock detect circuitry directly to the shock sensor for transmission of a translational shock signal; electrically connecting rapid off track shock detection circuitry to the vibration sensors for transmission of a rotation based shock signal; and electrically connecting shock aggregation circuitry to the translational shock signal and the rotation based shock signal for transmission of a composite shock indicator.

### TECHNICAL FIELD

The present invention relates generally to a hard disk drive system, and more particularly to a system with shock detection.

### BACKGROUND ART

A hard disk drive (HDD) is a recording device used to store information. Information is recorded on concentric tracks on the surface of a magnetic disk. The disk is mounted on a rotating spindle motor, and the information is accessed by a read/write head mounted on an actuator arm rotated by a voice coil motor (VCM).

An electrical current supplied to the VCM generates torque that moves the read/write head over the surface of the disk. The read head reads recorded information by sensing variations in a magnetic field associated with the surface of the disk.

A variable current is supplied to the write head to record information on the tracks. This current generates a magnetic field that selectively magnetizes the disk surface in relation to the information being recorded.

HDDs are used in many mobile or immobile products, such as personal computers, MP3, PDAs, cell phones, navigation systems, gaming systems, cameras, or large scale data centers. Market growth and demand for reliable, durable, low cost, and high performance HDDs are in ever increasing global demand.

It is extremely important that HDDs reliably record information when storing the information on to the magnetic disk. It is also equally important to prevent the storing of defective or bad information.

Mobile and immobile products containing HDDs can be subjected to undesirable human movement that can include movements from transporting, dropping, bumping, or even shaking. Additional undesirable movement can include naturally occurring movement such as air turbulence in an airplane, ocean tides experienced in a water vessel, or an earthy movement such as an earthquake experienced.

In view of the ever-increasing product market, growing consumer expectations, and the diminishing opportunities for meaningful product differentiation in the marketplace, it is critical that answers be found for these problems. Additionally, the need to reduce costs, improve reliability and product yields to meet competitive pressures adds an even greater urgency to the critical necessity for finding answers to these problems.

Solutions to these problems have been long sought after but prior developments have not taught or suggested any solutions and, thus, solutions to these problems have long eluded those skilled in the art.

### DISCLOSURE OF THE INVENTION

The present invention provides a method of manufacture of a hard disk drive system including: providing a base circuit board having a shock sensor and vibration sensors thereon; electrically connecting translational shock detect circuitry directly to the shock sensor for transmission of a translational shock signal; electrically connecting rapid off track shock detection circuitry to the vibration sensors for transmission of a rotation based shock signal; and electrically connecting shock aggregation circuitry to the translational shock signal and the rotation based shock signal for transmission of a composite shock indicator.

The present invention provides a hard disk drive system, including: a base circuit board having a shock sensor and vibration sensors thereon; translational shock detect circuitry connected directly to the shock sensor for transmission of a translational shock signal; rapid off track shock detection circuitry connected to the vibration sensors for transmission of a rotation based shock signal; and shock aggregation circuitry connected to the translational shock signal and the rotation based shock signal for transmission of a composite shock indicator.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a top plan view of a hard disk drive system in an embodiment of the present invention.

FIG. 2 is a bottom view of FIG. 1.

FIG. 3 is an exemplary diagram of shock sensory circuitry within the rapid off track module of FIG. 2.

FIG. 4 is a flow chart of a method of manufacture of the hard disk drive system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown greatly exaggerated in the drawing FIGs. Similarly, although the views in the drawings are shown for ease of description and generally show similar orientations, this depiction in the FIGs. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the present invention, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

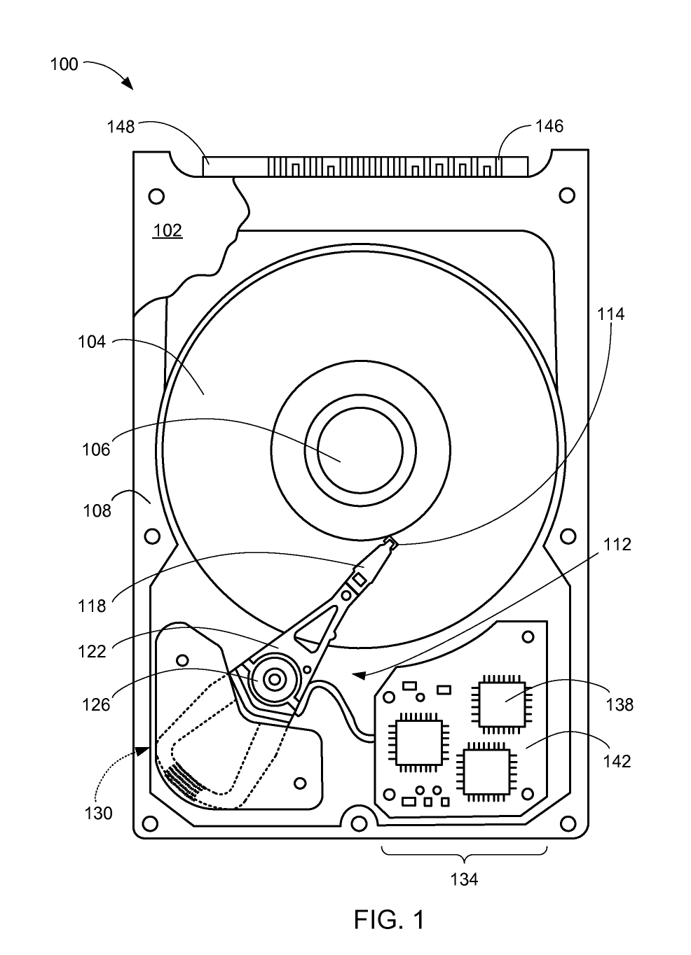

Referring now to FIG. 1, therein is shown a top plan view of a hard disk drive system 100 in an embodiment of the present invention. A portion of an outer side cover 102 covering components within the hard disk drive system 100 has been partially removed to show one or more disk 104 centrally supported by a spindle motor 106.

The disk 104 can be made of an aluminum alloy, ceramic/glass, or a similar non-magnetic material. Sides of the disk 104 can be covered with magnetic material deposited on one or both sides of the disk 104 to form a coating layer capable of magnetization.

The spindle motor 106 can rotate the disk 104 about a center of the disk 104 at constant or varying speeds. The spindle motor 106 can be attached to or part of a base assembly 108 of the hard disk drive system 100.

The base assembly 108 can be formed having at least one chamber or cavity. The components in the chamber can include the disk 104, the spindle motor 106, a head arm assembly 112, voice coil motor assembly 130, integrated circuitry (not shown), and flex cables (not shown). The flex cables can provide electrical connectivity between the components in the chamber normally covered by the outer side cover 102 and circuitry or a next level of integration outside the chamber.

A tapered end of the head arm assembly 112 can include a head 114 mounted to a flex arm 118 attached to an actuator arm 122 pivoted by a bearing assembly 126 to the base assembly 108. The head 114 can be suspended over the coating layer on the disk 104 by the flex arm 118 and the actuator arm 122. An end (shown in hidden lines) of the head arm assembly 112 opposite the tapered end having the head 114 can include a voice coil (shown in hidden lines) attached to the end of the head arm assembly 112. The voice coil can be coupled to a stationary magnet (not shown) to create the voice coil motor assembly 130.

The voice coil motor assembly 130 can be used to rotate the head arm assembly 112 about a center of the bearing assembly 126. The head 114 can be positioned over the disk 104 along an arc shaped path between an inner diameter of the coating layer and outer diameter of the coating layer.

For illustrative purposes, the head arm assembly 112 and the voice coil motor assembly 130 is configured for rotary movement of the head 114. The head arm assembly 112 and the voice coil motor assembly 130 can be configured to have a different movement. For example, the head arm assembly 112 and the voice coil motor assembly 130 could be configured to have a linear movement resulting in the head 114 traveling along a radius of the disk 104.

The head 114 can be positioned over the coating layer to create magnetic transitions or detect magnetic transitions from the coating layer that can be used to represent written data or read data, respectively. The hard disk drive system 100 may include a circuit assembly 134 that includes a plurality of integrated circuits 138 coupled to a printed circuit board 142. The circuit assembly 134 can be coupled to the voice coil motor assembly 130, the head 114, or the spindle motor 106 using interconnects that can include pins, cables, or wires (not shown).

Exposed contacts 146 of a drive connector 148 along a side end of the hard disk drive system 100 can be used to provide connectivity between circuitry of the hard disk drive system 100 and a next level of integration such as an interposer, a circuit board, a cable connector, or an electronic assembly. The drive connector 148 can include jumpers (not shown) or switches (not shown) that can be used to configure the hard disk drive system 100 for user specific features or configurations. The jumpers or switches can be recessed and exposed from within the drive connector 148.

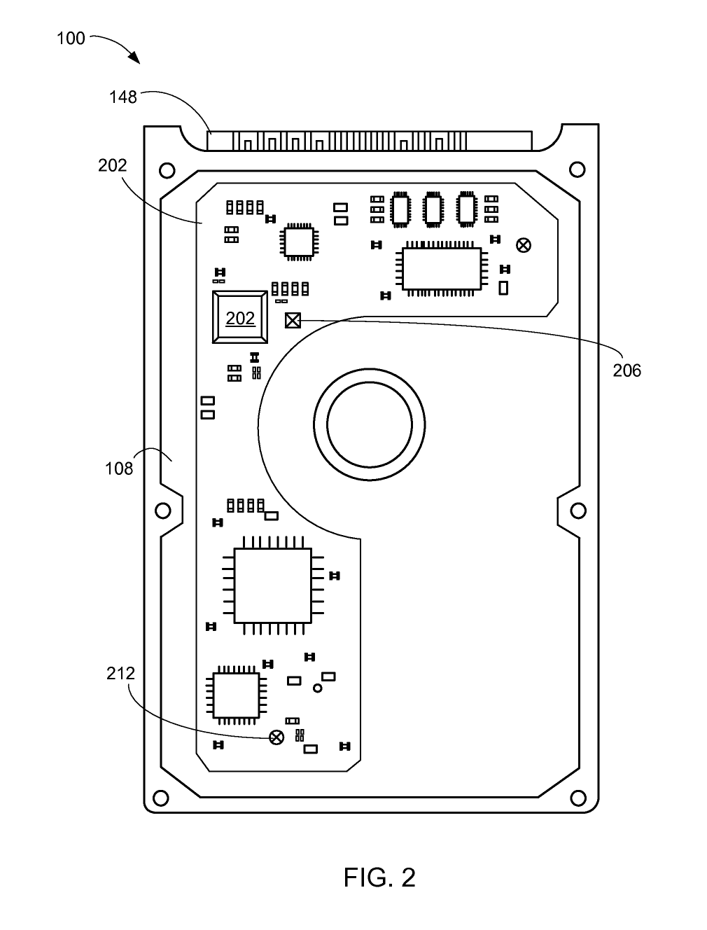

Referring now to FIG. 2, therein is shown a bottom view of FIG. 1. Shown is a base circuit board 202 with passive devices or integrated circuit devices electrically connected to the circuit assembly 134 of FIG. 1 or the drive connector 148. The base circuit board 202 can be mounted over an exterior side of the base assembly 108, opposite and facing away from the outer side cover 102 of FIG. 1. A shock sensor 206 and the rotational vibration sensors 212 can be mounted on the base circuit board 202.

The shock sensor 206 is sensitive to translational movements of the hard disk drive system 100. Translational movements can be defined as physical movement of the hard disk drive system 100 that is a direct result or attributed to non-rotational movement. The shock sensor 206 can be located anywhere on or within the hard disk drive system 100 to detect the shock events.

The rotational vibration sensors 212 are sensitive to rotational vibration from rotational forces applied to the hard disk drive system 100. The rotational vibration detected by the rotational vibration sensors 212 can be used to dynamically generate information representing magnitudes of rotational vibration or shock. The magnitudes of rotational vibration expressed as a voltage amplitude can be referred to as rotational vibration values.

Rotation based translational movements can be defined as physical movement of the hard disk drive system 100 that are a direct result or attributed to a rotational movement. The rotational vibration sensors 212 can also detect the rotation based translational movements as a result of force vectors of the rotational forces. The force vectors of the rotation based translational movements include movement or shock in a plane parallel with the rotational forces or outside the plane and angled with respect to the plane.

Each of the rotational vibration sensors 212 can be positioned at different locations on the hard disk drive system 100 to monitor rotational forces about pre-determined centers of rotation. Each of the rotational vibration sensors 212 can be at a pre-determined distance from the pre-determined centers of rotation to provide the rotational vibration sensors 212 with different levels of sensitivity to the rotational forces and the rotation based translational movements.

The rotation based translational movements can reflect changes in rotational acceleration, a harmonic vibration during a constant rotation velocity of the disk 104 of FIG. 1, a non-concentric rotation of the disk 104, a non-concentric rotation of the head arm assembly 112 of FIG. 1, or directional changes between clockwise rotation and counter-clockwise rotation of the head arm assembly 112. Shock from the translational movements or the rotation based translational movements can be defined as composite shock events or a composite shock event, depending on frequency and duration of movement occurrence.

The composite shock events can be used to generate a composite fault shock indicator signal or a composite shock event detected signal. The composite fault shock indicator signal can be used by the rapid off track module 218 of the hard disk drive system 100, circuitry external to the hard disk drive system 100, or a combination thereof to improve data integrity. The data integrity improvements can include execution of recovery/retry data operations, data back-up or archival operations, alternate data routing to backup hard disk drive system similar to the hard disk drive system 100, cache buffering data, or a combination thereof.

The composite shock event detected signal can be recorded and used to indicate single or multiple occurrences of shock events for purposes of analysis, disk maintenance, performance, projection of product life expectancy, or a combination thereof. Information compiled from the shock event detected signal can be stored in non-volatile memory of the hard disk drive system 100, the disk 104, external to the hard disk drive system 100, or a combination thereof. The composite shock event detected signal can be derived from the composite fault shock indicator signal.

One or more of the rotational vibration values can be used by the rapid off track module 218, or software, or a combination thereof to cancel or minimize rotational vibration using various head seek profiles or disk spin profiles. The seek profiles can include controlling acceleration rates of the head arm assembly 112, deceleration rates of the head arm assembly 112, dampened movement of the head arm assembly 112 movement, or seek over/under shoot of the head arm assembly 112 using the voice coil motor assembly 130 of FIG. 1.

The disk spin profiles can include controlling acceleration rates during velocity increases of rotation speed of the disk 104, velocity decreases of rotation speed of the disk 104, or non-contiguous step changes in rotation speed of the disk 104 using the spindle motor 106 of FIG. 1. The rotational vibration values provides the rapid off track module 218 or the software the capability to monitor and dynamically adapt the head seek profiles or disk spin profiles to maximize performance, reliability, or data integrity based on user requirements or operating environments.

It has been discovered that the rotational vibration sensors 212 can be used to detect both rotational vibration and rotation based translational movement of the hard disk drive system 100 for purposes of predicting or averting eminent failure of the hard disk drive system 100 and providing superior product reliability and data integrity.

It has further been discovered that the shock sensor 206 in conjunction with the rotational vibration sensors 212 will detect more shocks from internal or external shock events than a typical hard disk drive relying solely on a shock sensor.

It has yet further been discovered that the rotational vibration values derived from the rotational vibration sensors 212 and the rapid off track (ROT) technology provide additional shock event accuracy and greater product reliability over typical hard disk drives.

It has been unexpectedly found that the rotational vibration sensors 212 provide placement flexibility at different locations of the base circuit board 202 resulting in significant improvements in the sensitivity and detection of shock by the rotational vibration sensors 212.

It has been unexpectedly determined that the rapid off track implementations using only one shock sensor and the rotational vibration sensors 212 for additional shock information to capture or detect all rapid off track events or shocks provides a more robust capture and detection of rapid off track events than any rapid off track implementation using only shock sensors.

It has been unexpectedly observed that the rotational vibration sensors 212 are capable of capturing not only X-axis and Y-axis directed shock, but also capture Z-axis shock and rapid off track events.

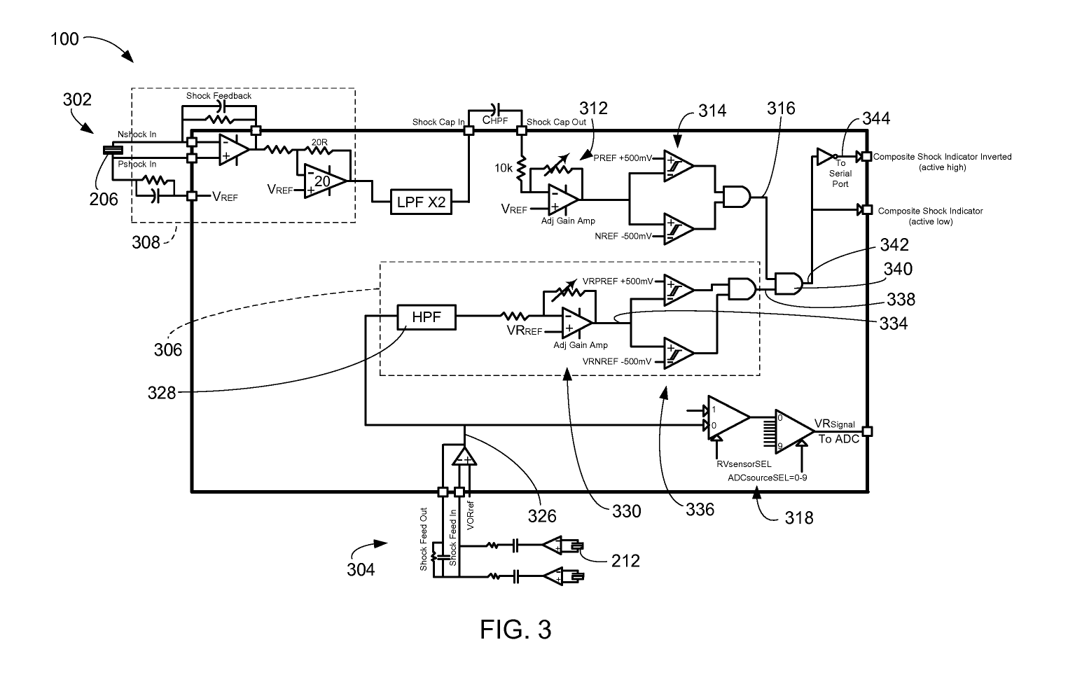

Referring now to FIG. 3, therein is shown an exemplary diagram of shock sensory circuitry within the rapid off track module 218 of FIG. 2. The shock sensory circuitry can include translational shock detect circuitry 302, rotational vibration sensor circuitry 304, and rapid off track shock detection circuitry 306. The shock sensory circuitry can be included in the rapid off track module 218 of FIG. 2.

For illustrative purposes, some component information such as resistor values, capacitor values, and reference voltages and supply voltages of operational amplifiers are not shown. The component information can vary and depend on specific requirements the components and circuitry of the hard disk drive system 100. For example, a hard disk drive system having positive 5 volts, negative 5 volts, and positive 12 volts will likely not have any operational amplifiers designed to operate with positive 9 volts and negative 9 volts.

For purposes of discussion, values such as resistor values, capacitor values, and reference voltages and supply voltages of operational amplifiers are not specified. These values can be predetermined and based on specific requirements of components used and associated with the hard disk drive system 100.

The translational shock detect circuitry 302 includes a cascaded amplifier 308 with a differential input connected directly to the shock sensor 206 and absent of any intervening component between the shock sensor 206 and the differential input of the cascaded amplifier 308. The cascaded amplifier 308 can be designed with a high impedance input and provide a pre-determined gain and signal to noise ratio to amplify signals from the shock sensor 206.

The output of the last stage of the cascaded amplifier 308 can be connected directly to the input of a low pass filter of the translational shock detect circuitry 302 to block high frequency signals or noise received from the shock sensor 206. An output of the low pass filter can be ac coupled to an input of a programmable gain amplifier 312 of the translational shock detect circuitry 302.

A signal amplitude output level from an output of the programmable gain amplifier 312 to an input of a shock comparator circuit 314 of the translational shock detect circuitry 302 can be dynamically adjusted by circuitry of the programmable gain amplifier 312 for optimum signal sensitivity, thresholds, or detection by the shock comparator circuit 314. The shock comparator circuit 314 of the translational shock detect circuitry 302 monitors a window or an envelope of the signal amplitude output level from the programmable gain amplifier 312 and outputs or transmits a translational shock signal 316 having either a low voltage or high voltage potential level.

The translational shock signal 316 is at the low voltage potential level if the signal amplitude output level swings beyond a high or low voltage threshold value predetermined, bounded, and set by the positive reference voltage (PREF) or negative reference voltage (NREF) reference inputs of the shock comparator circuit, respectively. The translational shock signal 316 is at the high voltage potential level when the signal amplitude output level swings are not exceeding the predetermined high or low voltage threshold. The translational shock signal 316 at a low voltage potential level indicates a shock from a translational movement has been detected by the shock sensor 206.

The rotational vibration sensor circuitry 304 includes individual pre-amplifiers with differential inputs of each of the pre-amplifiers connected directly to one of the rotational vibration sensors 212 and absent of any intervening component between the rotational vibration sensors 212 and the differential inputs of each of the pre-amplifiers. Outputs of the pre-amplifiers are connected to an input of an amplifier in an additive manner to generate an amplified and conditioned single ended composite vibration output signal 326.

The composite vibration output signal 326 can be directly connected to an analog multiplexor circuit 318 for analog to digital conversion to eliminate rotational vibration. The analog multiplexor circuit 318 is shown having circuitry to select from at least one composite vibration output signal source or other analog signals to be sent to an analog to digital converter (not shown) for processing rotational vibration.

The analog to digital converter can be used to sample the composite vibration output signal 326 and generate digital values representing a voltage level of the sample. The digital values can be referred to as the rotational vibration values.

The composite vibration output signal 326 is directed to the rapid off track shock detection circuitry 306 to extract rotation based translational movement information. The composite vibration output signal 326 is directly connected to an input of a high pass filter 328 of the rapid off track shock detection circuitry 306 to remove low frequency signal components from the composite vibration output signal 326 and to pass a high frequency rotation based movement signal.

The high frequency rotation based movement signal from the high pass filter 328 is directly connected to a rotational vibration gain amplifier 330 of the rapid off track shock detection circuitry 306, similar to the programmable gain amplifier 312 used to process shock information from the shock sensor 206. An amplified rotation based movement signal 334 from an output of the rotational vibration gain amplifier 330 to an input of a rotation based shock comparator circuit 336 of the rapid off track shock detection circuitry 306 can be programmed or dynamically adjusted by circuitry of the rotational vibration gain amplifier 330 for optimized signal sensitivity, thresholds, or detection. The rotation based shock comparator circuit 336 can include a window comparator having fixed vibration rotational negative reference voltage (VRNREF) and vibration rotational positive reference voltage (VRPREF) reference inputs to set envelope threshold trigger voltages.

The rotation based shock comparator circuit 336 of the rapid off track shock detection circuitry 306 monitors a window or an envelope of the amplified rotation based movement signal 334 from the rotational vibration gain amplifier 330 and outputs or transmits a rotation based shock signal 338 having a low voltage or high voltage potential levels based on the envelope threshold trigger voltages. The rotation based shock signal 338 is at the low voltage potential level if the signal amplitude output level swings beyond a high or low voltage threshold value predetermined, bounded, and set by the VRPREF or VRNREF inputs of the shock comparator circuit, respectively.

The rotation based shock signal 338 is at the high voltage potential level when the signal amplitude output level swings are not exceeding the predetermined high or low voltage threshold. The rotation based shock signal 338 at a low voltage potential level indicates that a shock from rotation based translational movements has been detected by the rotational vibration sensors 212.

Optionally, timed interval voltage swing sampling circuitry can be included to sample and record changes of highest or lowest voltage swings of the amplified rotation based movement signal 334 over a predetermined time interval. The recorded changes can be used by circuitry or software to dynamically adjust amplification gain settings of the rotational vibration gain amplifier 330 to provide rapid off track shock detection that is adaptable to various different vibration environments.

Shock aggregation circuitry 340 generate or transmit a composite shock indicator 342 to indicate a shock from rotation based translational movements or translational movements by monitoring the rotation based shock signal 338 or the translational shock signal 316 for a low voltage potential level, respectively. The shock aggregation circuitry 340 continually monitors the rotation based shock signal 338 and the translational shock signal 316 for any shock event while the hard disk drive system 100 is in operation.

For purposes of illustration, the composite shock indicator 342 and a composite shock indicator inverted 344 is shown. The composite shock indicator 342 can be used to generate any number of indicators for distribution within and external to the hard disk drive system 100. For example, the composite shock indicator 342 and the composite shock indicator inverted 344 can be buffered and used to generate the composite fault shock indicator signal and the composite shock event detected signal previously described in the description of FIG. 2.

It has been discovered that dynamic adjustments of the rotational vibration gain amplifier 330 based on timed interval voltage swing samples of the amplified rotation based movement signal 334 provides consistent rapid off track detection results in various different vibration environments to improve shock detection sensitivity while reducing interference from background vibration noise.

It has further been discovered that the translational shock detect circuitry 302 with the shock sensor 206, the rotational vibration sensor circuitry 304, the rapid off track shock detection circuitry 306 with the rotational vibration sensors 212, and the shock aggregation circuitry 340 captures more shock events resulting in enhanced rapid off-track detection capabilities.

It has yet further been discovered that the translational shock detect circuitry 302, the rotational vibration sensor circuitry 304, and the rapid off track shock detection circuitry 306 with the rotational vibration sensors 212 significantly increases product reliability of the hard disk drive system 100 by improving data integrity.

It has yet further been discovered that the translational shock detect circuitry 302, the rotational vibration sensor circuitry 304, the rapid off track shock detection circuitry 306, the rotational vibration sensors 212, the shock sensor 206, and the shock aggregation circuitry 340 provide the composite shock indicator 342 to trigger a write fault error to improve data integrity.

It has yet further been discovered that using magnitudes of the digital values representing voltage levels of the composite vibration output signal 326 from the rotational vibration sensor circuitry 304 with the rotational vibration sensors 212 to activate a write fault when the magnitudes exceed a pre-defined registered voltage threshold limit significantly increases data integrity protection capabilities.

It has yet further been discovered that the high pass filter 328 of the rapid off track shock detection circuitry 306 amplifies the high frequency signal to increase shock signal detection and significantly reduces rotary vibration components from the signals generated by the rotational vibration sensors 212 to provide improved shock fault detection and improve product reliability.

It has yet further been discovered that sensitivities of the rapid off track shock detection circuitry 306 can be dynamically adjusted based on average amplitude of low frequency components in the composite vibration output signal 326 to provide superior rapid off track (ROT) detection over a conventional hard disk drive system.

It has yet further been discovered that the shock sensor 206, the rotational vibration sensors 212, the voice coil motor assembly 130 of FIG. 1, the spindle motor 106 of FIG. 1, the translational shock detect circuitry 302, the rotational vibration sensor circuitry 304, the rapid off track shock detection circuitry 306, and the shock aggregation circuitry 340 provide a robust adaptive closed loop system to improve the reliability of any hard disk drive system.

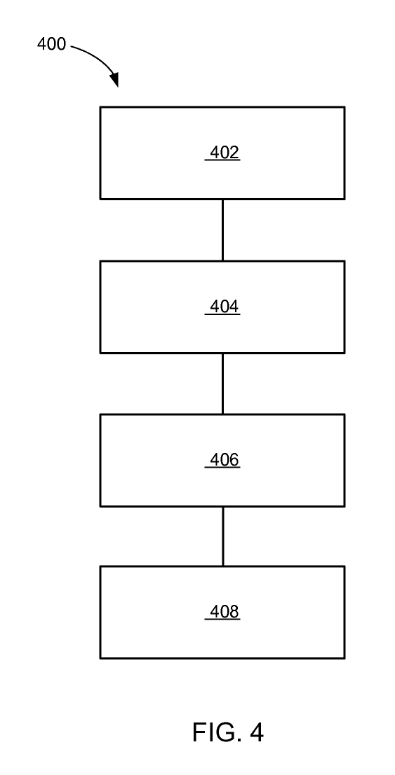

Referring now to FIG. 4, therein is shown is a flow chart of a method 400 of manufacture of the hard disk drive system 100 in a further embodiment of the present invention. The method 400 includes: providing a base circuit board having a shock sensor and vibration sensors thereon in a block 402; electrically connecting translational shock detect circuitry directly to the shock sensor for transmission of a translational shock signal in a block 404; electrically connecting rapid off track shock detection circuitry to the vibration sensors for transmission of a rotation based shock signal in a block 406; and electrically connecting shock aggregation circuitry to the translational shock signal and the rotation based shock signal for transmission of a composite shock indicator in a block 408.

Thus, it has been discovered that the hard disk drive system with the present invention furnishes important and heretofore unknown and unavailable solutions, capabilities, and functional aspects. The resulting method, process, apparatus, device, product, and/or system is straightforward, cost-effective, uncomplicated, highly versatile and effective, can be surprisingly and unobviously implemented by adapting known technologies, and are thus readily suited for efficiently and economically manufacturing package in package systems/fully compatible with conventional manufacturing methods or processes and technologies.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of manufacture of a hard disk drive system comprising:
providing a base circuit board having a shock sensor and vibration sensors thereon;
electrically connecting translational shock detect circuitry directly to the shock sensor for transmission of a translational shock signal;
electrically connecting rapid off track shock detection circuitry to the vibration sensors for transmission of a rotation based shock signal; and
electrically connecting shock aggregation circuitry to the translational shock signal and the rotation based shock signal for transmission of a composite shock indicator.

2. The method as claimed in claim 1 wherein electrically connecting the rapid off track shock detection circuitry includes electrically connecting a high pass filter of the rapid off track shock detection circuitry to the vibration sensors.

3. The method as claimed in claim 1 further comprising electrically connecting rotational vibration sensor circuitry between the vibration sensors and the rapid off track shock detection circuitry.

4. The method as claimed in claim 1 wherein electrically connecting the rapid off track shock detection circuitry includes electrically connecting a rotational vibration gain amplifier of the rapid off track shock detection circuitry directly to a high pass filter for optimum signal sensitivity.

5. The method as claimed in claim 1 wherein electrically connecting the rapid off track shock detection circuitry includes electrically connecting the rapid off track shock detection circuitry with a rotation based shock comparator circuit directly to a rotational vibration gain amplifier to transmit a rotation based shock signal based on threshold trigger values.

6. A method of manufacture of a hard disk drive system comprising:
providing a base circuit board having a shock sensor and vibration sensors thereon;
electrically connecting translational shock detect circuitry directly to the shock sensor for transmission of a translational shock signal;
electrically connecting rapid off track shock detection circuitry to the vibration sensors for transmission of a rotation based shock signal;
electrically connecting shock aggregation circuitry to the translational shock signal and the rotation based shock signal for transmission of a composite shock indicator; and
electrically connecting an analog multiplexor circuit to the vibration sensors to select the vibration sensors for analog to digital conversion.

7. The method as claimed in claim 6 wherein electrically connecting the rapid off track shock detection circuitry includes electrically connecting a high pass filter of the rapid off track shock detection circuitry to remove low frequency signal components of the vibration sensors.

8. The method as claimed in claim 6 further comprising electrically connecting rotational vibration sensor circuitry with pre-amplifiers between the vibration sensors and the rapid off track shock detection circuitry, the pre-amplifiers connected directly to the vibration sensors.

9. The method as claimed in claim 6 wherein electrically connecting the rapid off track shock detection circuitry includes electrically connecting a rotational vibration gain amplifier of the rapid off track shock detection circuitry directly to a high pass filter for dynamic adjustments to optimize signal sensitivity.

10. The method as claimed in claim 6 wherein electrically connecting the rapid off track shock detection circuitry includes electrically connecting the rapid off track shock detection circuitry with a rotation based shock comparator circuit directly to a rotational vibration gain amplifier for transmitting a rotation based shock signal based on fixed envelope threshold trigger values.

11. A hard disk drive system comprising:
a base circuit board having a shock sensor and vibration sensors thereon;
translational shock detect circuitry connected directly to the shock sensor for transmission of a translational shock signal;
rapid off track shock detection circuitry connected to the vibration sensors for transmission of a rotation based shock signal; and
shock aggregation circuitry connected to the translational shock signal and the rotation based shock signal for transmission of a composite shock indicator.

12. The system as claimed in claim 11 wherein the rapid off track shock detection circuitry includes a high pass filter connected to the vibration sensors.

13. The system as claimed in claim 11 further comprising rotational vibration sensor circuitry connected between the vibration sensors and the rapid off track shock detection circuitry.

14. The system as claimed in claim 11 wherein the rapid off track shock detection circuitry includes a rotational vibration gain amplifier directly connected to a high pass filter for optimum signal sensitivity.

15. The system as claimed in claim 11 wherein the rapid off track shock detection circuitry includes a rotation based shock comparator circuit directly connected to a rotational vibration gain amplifier for transmission of a rotation based shock signal based on threshold trigger values.

16. The system as claimed in claim 11 further comprising an analog multiplexor circuit connected to the vibration sensors to select the vibration sensors for analog to digital conversion.

17. The system as claimed in claim 16 wherein the rapid off track shock detection circuitry includes a high pass filter to remove low frequency signal components of the vibration sensors.

18. The system as claimed in claim 16 further comprising rotational vibration sensor circuitry with pre-amplifiers between the vibration sensors and the rapid off track shock detection circuitry, the pre-amplifiers connected directly to the vibration sensors.

19. The system as claimed in claim 16 wherein the rapid off track shock detection circuitry includes a rotational vibration gain amplifier connected directly to a high pass filter for dynamic adjustments to optimize signal sensitivity.

20. The system as claimed in claim 16 wherein the rapid off track shock detection circuitry includes a rotation based shock comparator circuit connected directly to a rotational vibration gain amplifier for transmission of a rotation based shock signal based on fixed envelope threshold trigger values.
